(19) United States
(12) Patent Application Publication
(10) Pub. No.: US 2010/0254539 A1
(43) Pub. Date: Oct. 7, 2010

(54) APPARATUS AND METHOD FOR EXTRACTING TARGET SOUND FROM MIXED SOURCE SOUND

(75) Inventors: So-young JEONG, Seoul (KR); Kwang-cheol Oh, Yongin-si (KR); Jae-hoon Jeong, Yongin-si (KR); Kyu-hong Kim, Suwon-si (KR)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/754,990

(22) Filed: Apr. 6, 2010

(30) Foreign Application Priority Data
Apr. 7, 2009 (KR) 10-2009-0029957

(51) Int. Cl. H04R 29/00; H04B 15/00

(52) U.S. Cl. 381/56; 381/94.1

(57) ABSTRACT

A technology for eliminating or reducing interference sound from a sound signal to extract target sound is provided. Interference sound is modeled using training noise, and mixed source sound is separated using the modeled interference sound. The mixed source sound is separated into target sound and interference sound using a basis matrix of the modeled interference sound.

### CROSS-REFERENCE TO RELATED APPLICATION(S)

This application claims the benefit under 35 U.S.C. §119(a) of Korean Patent Application No. 10-2009-0029957, filed on Apr. 7, 2009, in the Korean Intellectual Property Office, the entire disclosure of which is incorporated herein by reference for all purposes.

### BACKGROUND

1. Field

The following description relates to a technology of extracting target sound from mixed source sound.

2. Description of the Related Art

In consumer electronics (CE) devices having various sound input functions, there are cases where interference sound, etc. is input thereto. For example, in the case of digital cameras/camcorders, the case where motor noise of a zoom lens is recorded with other sound often occurs when a user executes an optical zoom function while recording. Such motor noise may be harsh on users ears.

In order to address the problem, a method of manually turning off a sound input function when executing an optical zoom function, a method of utilizing an expensive silent wave motor (SWM), and others have been used.

However, in the case of a Digital Single-lens Reflex (DSLR) camera with a non built in lens, there is no method capable of mechanically reducing such noise as motor noise from being input from the external lens while recording. Also, there is the case where noise made by the pressing of a camera shutter is recorded when photographing a still image while recording video. In addition, there is the case where noise made by the pressing of keyboard buttons or by the clicking of mouse buttons is recorded together when a user records a lecture or meeting with a portable audio/voice recorder/laptop. In a spoken dialog system for a robot, it is advantageous to eliminate noise made by a motor installed inside a robot.

The characteristics of such noise are in that the noise is nonstationary, impulsive and transient. In order to eliminate such nonstationary, impulsive and transient noise using a general noise elimination method, a process of detecting noise accurately, estimating a noise spectrum for the noise and then eliminating it is needed.

However, since the characteristics of noise are nonstationary, impulsive and transient, as described above, errors may occur in detecting such noise when it is generated. Furthermore, if the interference noise is louder than the target sound, the target sound may be eliminated together upon elimination of noise spectrums, which can lead to sound distortion.

### SUMMARY

In one aspect, there is provided a target sound extracting apparatus including a modeling unit configured to extract a basis matrix of training noise, and a sound analysis unit configured to separate received mixed source sound into target sound and interference sound using the basis matrix of the training noise.

The interference sound may be modeled as the basis matrix of the training noise.

The modeling unit my transform the training noise to training noise in a time-frequency domain and apply non-negative matrix factorization (NMF) to the transformed training noise.

The sound analysis unit may apply negative matrix factorization (NMF) to the mixed source sound under a presumption that the basis matrix of the training noise is the same as a basis matrix of the interference sound.

The sound analysis unit may initialize a basis matrix of the target sound to an arbitrary value, estimate a coefficient matrix of the mixed source sound, and estimate the basis matrix of the target sound using the coefficient matrix of the mixed source sound.

The sound analysis unit may separate the mixed source sound into target sound and interference sound that do not share any common components on a sound spectrogram.

The target sound extracting apparatus may further include a filter unit configured to eliminate the interference sound from the mixed source sound.

The filter unit may apply an adaptive filter for reinforcing the target sound and weakening the interference sound of the mixed source sound.

In another aspect, there is provided a target sound extracting method including extracting a basis matrix of training noise, and separating received mixed source sound into target sound and interference sound using the basis matrix of the training noise.

The interference sound may be modeled as the basis matrix of the training noise.

The extracting of the basis matrix of the training noise may include transforming the training noise to training noise in a time-frequency domain, and applying non-negative matrix factorization (NMF) to the transformed training noise.

The separating of the received mixed source sound into the target sound and the interference sound may include applying negative matrix factorization (NMF) to the mixed source sound under a presumption that the basis matrix of the training noise is the same as a basis matrix of the interference sound.

The separating of the received mixed source sound into the target sound and the interference sound may include initializing a basis matrix of the target sound to an arbitrary value, estimating a coefficient matrix of the mixed source sound, and estimating the basis matrix of the target sound using the coefficient matrix of the mixed source sound.

The separating of the received mixed source sound into the target sound and the interference sound may include separating the mixed source sound into target sound and interference sound that do not share any common components on a sound spectrogram.

The target sound extracting may further include eliminating the interference sound from the mixed source sound, wherein the eliminating of the interference sound may include applying an adaptive filter for reinforcing the target sound and weakening the interference sound of the mixed source sound.

Other features and aspects will be apparent from the following detailed description, the drawings, and the claims.

### BRIEF DESCRIPTION OF THE DRAWINGS

FIG. 1 is a diagram illustrating an apparatus of extracting target sound from mixed source sound, according to an example embodiment.

FIG. 2 is a diagram showing a configuration of a modeling unit illustrated in FIG. 1, is according to an example embodiment.

FIG. 3 is a diagram showing a configuration of a sound analysis unit illustrated in FIG. 1, according to an example embodiment.

FIG. 4 is a diagram showing a configuration of a filter unit illustrated in FIG. 1, according to an example embodiment. FIG. 5 is a flowchart illustrating a target sound extracting method according to an example embodiment.

FIG. 6 is a flowchart illustrating a semi-blind NMF method according to an example embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of well-known functions and constructions may be omitted for increased clarity and conciseness.

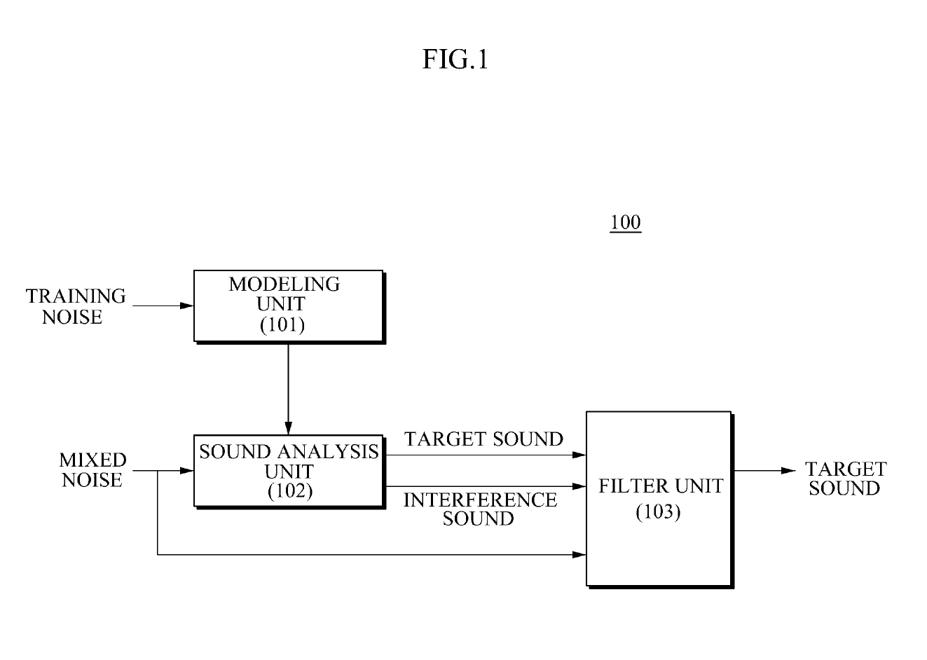

FIG. 1 illustrates an apparatus suitable for extracting target sound from mixed source sound, according to an example embodiment. The target sound extracting apparatus 100 can extract desired sound by eliminating or reducing nonstationary, impulsive or transient noise generated in various digital portable devices.

In the current example embodiment, the target sound may be a sound signal to be extracted, and interference sound may be an interference sound signal excluding such a target sound signal. For example, in the case of a digital camcorder or camera, voice of persons to be photographed may be target sound, and sound generated by the machine upon execution of functions such as zoom-in or -out may be interference sound.

As an example, the target sound extracting unit 100 may be applied to digital camcorders and cameras in order to eliminate or reduce machine sound generated upon execution of a zoom-in or zoom-out function, etc. As another example, the target sound extracting apparatus 100 may be applied to a spoken dialog system of a robot in order to eliminate or reduce noise made by a motor of a robot, or may be applied to a digital portable sound-recording apparatus in order to eliminate or reduce noise made by button manipulations.

Referring to FIG. 1, the target sound extracting apparatus 100 includes a modeling unit 101, a sound analysis unit 102 and a filter unit 103.

The sound analysis unit 102 separates mixed source sound into target sound and interference sound. Here, the interference sound may be machine driving sound, motor sound, sound made by button manipulations, etc., and the target sound may be remaining sound excluding the interference sound.

The sound analysis unit 102 separates mixed source sound into target sound and interference sound using a signal analysis technology according to an example embodiment. Here, information about the interference sound may be provided by modeling data from the modeling unit 101.

The modeling unit 101 may create modeling data using training noise. The training noise corresponds to the interference sound. For example, if the target sound extracting apparatus 100 is applied to a digital camcorder, the training noise may be machine driving sound, motor sound, sound made by button manipulations, etc.

The interference sound is nonstationary, implusive or transient sound which is mixed in mixed source sound, and the training sound may be sound programmed in the format of a profile in the corresponding device when the device was manufactured or may be sound acquired by a user before he or she uses a noise elimination function according to an example embodiment. In the case of a digital camcorder, a user may acquire training noise by driving a zoom-in/out function on its lens before recording.

The modeling unit 101, which receives the training noise, may transform the training noise into a basis matrix and a coefficient matrix using non-negative matrix factorization (NMF). The NMF is a signal analysis technique and transforms a certain data matrix into two matrices composed of non-negative elements.

The sound analysis unit 102 may separate mixed source sound into target sound and interference sound using the output of the modeling unit 101, that is, using the basis matrix of the training noise. The NMF according to the current example embodiment may be called semi-blind NMF. For example, the sound analysis unit 102 may consider a basis matrix of training noise as a basis matrix of interference sound and apply semi-blind NMF to the mixed source sound.

The sound analysis unit 102 may separate the mixed source sound by applying the semi-blind NMF. Also, the sound analysis unit 102 may separate the mixed source sound into target sound and interference sound that meet having orthogonal disjointedness to each other. Analysis considering orthogonal disjointedness means separating the mixed source sound into target sound and interference sound, which do not share any common components on a sound spectrogram. Presence of a common component in two signals may mean the case where the same value is assigned to corresponding coordinate locations on the time-frequency graphs of the two signals. According to an example embodiment, separation of mixed source sound is performed in such a manner that if a target sound component corresponding to a certain coordinate location on a sound spectrogram is “1”, an interference sound component corresponding to the same coordinate location becomes “0”.

The filter unit 103 may generate an adaptive filter using the target sound and interference sound. Here, the adaptive filter acts to reinforce target sound and weaken interference sound in order to extract enhanced target sound. The filter unit 103 passes the mixed source sound through such an adaptive filter, thus eliminating the interference sound from the mixed source sound.

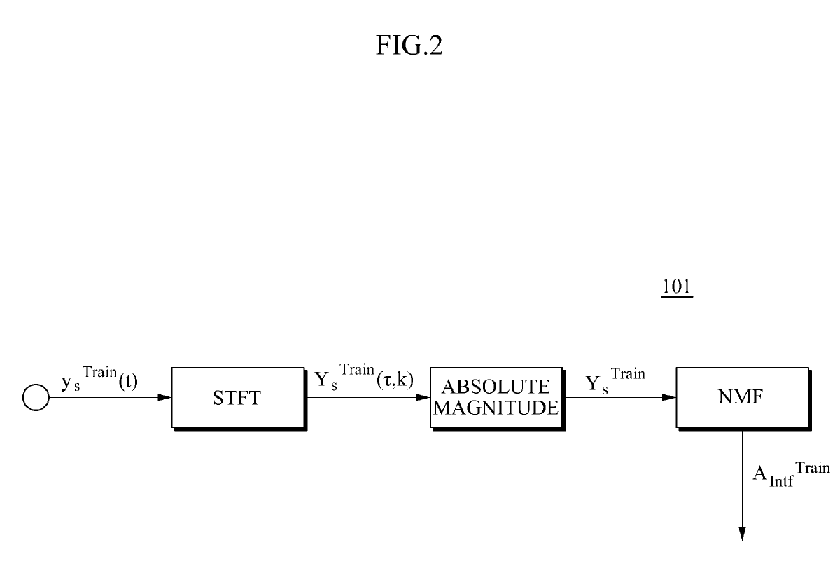

Now, the modeling unit 101 and a method of extracting a basis matrix of training noise are described with reference to FIG. 2. The method may be an example of a method of modeling a basis matrix of interference sound.

In FIG. 2, y_{S}^{Train}(t) may represents training noise in a time domain. y_{S}^{Train}(t) may be transformed to Y_{S}^{Train}(τ,k) in a time-frequency domain by Short-Time Fourier Transform (STFT). Here, τ may represent a time-frame axis and k represents a frequency axis. In addition, the absolute value of Y_{S}^{Train}(τ,k) is referred to as Y_{S}^{Train}.

Y_{S}^{Train} may be transformed into a basis matrix having m×r elements and a coefficient matrix having r×T elements, as expressed by Equation 1 below. Here, r may represent the number of basis vectors constructing the basis matrix, and V in Equation 1 may represent a modeling error.

Y_{S}^{Train}=A_{S}^{Train}, X_{S}^{Train}+V (1)

In order to obtain the basis matrix A_{S}^{Train} and the coefficient matrix X_{S}^{Train}, a mean-squared error criterion may be defined as follows.

$$l = \frac{1}{2} {‖ {Y}_{s}^{Train} - {A}_{s}^{Train} \cdot {X}_{s}^{Train} ‖}_{2}^{2} \qquad ( 2 )$$

By applying a steepest-decent technique to Equation 2, the basis matrix A_{S}^{Train} can be obtained. For example, gradients can be calculated using Equation 3 and the matrices X_{S}^{Train} and A^{S}^{Train} can be updated using Equation 4.

$$\begin{matrix}\frac{\partial l}{\partial {X}_{s}^{Train}} = {( {A}_{s}^{Train} )}^{T} {Y}_{s}^{Train} - {( {A}_{s}^{Train} )}^{T} ( {A}_{s}^{Train} ) {X}_{s}^{Train} \\ \frac{\partial l}{\partial {A}_{s}^{Train}} = {{Y}_{s}^{Train} ( {X}_{s}^{Train} )}^{T} - {A}_{s}^{Train} {{X}_{s}^{Train} ( {X}_{s}^{Train} )}^{T} & ( 3 ) \\ {X}_{s}^{Train} ← {X}_{s}^{Train} + {η}_{X} \frac{\partial l}{\partial {X}_{s}^{Train}} \\ {X}_{s}^{Train} = {X}_{s}^{Train} ⊗ {( {A}_{s}^{Train} )}^{T} {Y}_{s}^{Train} {Θ ( {A}_{s}^{Train} )}^{T} {A}_{s}^{Train} {X}_{s}^{Train} \\ where {η}_{X} = \frac{{X}_{s}^{Train}}{{( {A}_{s}^{Train} )}^{T} {A}_{s}^{Train} {X}_{s}^{Train}} \\ {A}_{s}^{Train} ← {A}_{s}^{Train} + {η}_{A} \frac{\partial l}{\partial {A}_{s}^{Train}} \\ {A}_{s}^{Train} = {A}_{s}^{Train} ⊗ {{Y}_{s}^{Train} ( {X}_{s}^{Train} )}^{T} {ΘA}_{s}^{Train} {{X}_{s}^{Train} ( {X}_{s}^{Train} )}^{T} \\ where {η}_{A} = \frac{{A}_{s}^{Train}}{{A}_{s}^{Train} {{X}_{s}^{Train} ( {X}_{s}^{Train} )}^{T}} & ( 4 )\end{matrix}$$

In Equation 4, \textcircled{×}and \textcircled{−} may represent Hadamard matrix operators.

The basis matrix A_{S}^{Train} of transiting noise is the same as A_{Intf}^{Train} of FIG. 2 and may be used as the basis matrix of interference sound to be eliminated.

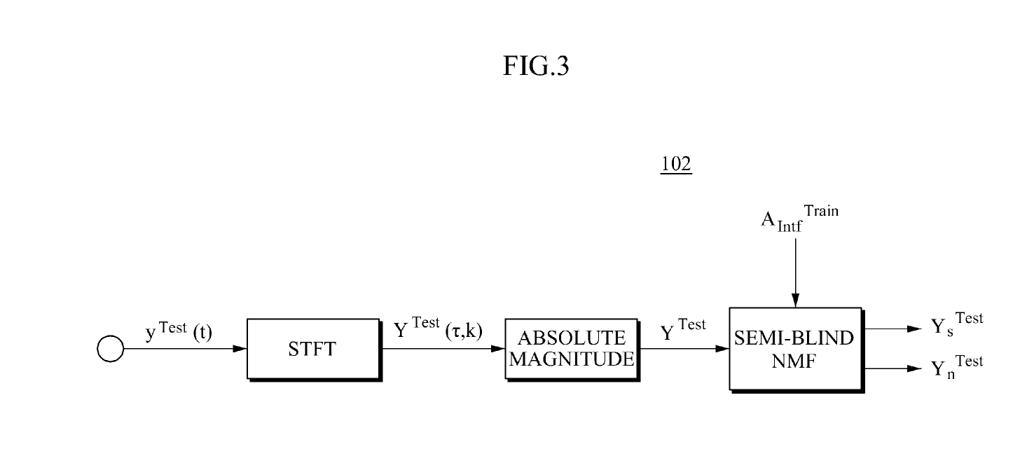

Now, the sound analysis unit 102 and a method of separating mixed source sound into target sound and interference sound are described with reference to FIG. 3. This method may be an example of applying semi-blind NMF according to an example embodiment.

In FIG. 3, y^{Test}(t) may represent mixed source sound in a time domain. y^{Test}(t) may be transformed to Y^{Test}(τ,k) in a time-frequency domain by Short-Time Fourier Transform (STFT). Here, τ may represent a time-frame axis and k represents a frequency axis. In addition, the absolute value of Y^{Test}(τ, k) may be referred to as T^{Test}.

Y^{Test} may be separated into target sound Y_{S}^{Train} and interference sound Yⁿ^{Test} by semi-blind NMF. The separation may be expressed by Equation 5, below.

$$\begin{matrix}{Y}^{Test} = {A}^{Test} {X}^{Test} + {V}^{Test} = [ \begin{matrix}{A}_{s}^{Test} & {A}_{n}^{Test} ] [ \begin{matrix}{X}_{s}^{Test} \\ {X}_{n}^{Test}\end{matrix} ] + {V}^{Test}\end{matrix} \\ = {A}_{s}^{Test} {X}_{s}^{Test} + {A}_{n}^{Test} {X}_{n}^{Test} + {V}^{Test} \\ = {Y}_{s}^{Test} + {Y}_{n}^{Test} + {V}^{Test}\end{matrix} \qquad ( 5 )$$

In Equation 5, it may be presumed that a basis matrix A^{S}^{Test} of target sound is initialized to an arbitrary value, and a basis matrix Aₙ^{Test} of interference sound is the same as the basis matrix A_{Intf}^{Train} of training noise calculated by Equations 1 through 4.

As such, since Y^{Test} and A^{Test} may be given by Equation 5, the coefficient matrix X^{Test} may be estimated by a least square technique. Also, the basis matrix A_{S}^{Test} of target sound may be again estimated using the coefficient matrix X^{Test}.

In this case, an error criterion may be set up in consideration of applications of Equations 2, 3 and 4, or may be set up considering orthogonal disjointedness described above, as in the following Equation 6.

$${J}_{disjoint} = \frac{1}{2} {‖ Y - {A}_{s} {X}_{s} - {A}_{n} {X}_{n} ‖}_{F}^{2} + {βΦ}_{d} ( {A}_{s} , {X}_{s} , {X}_{n} ) \\ s . t . {[ {A}_{s} ]}_{ij} ≧ 0 , {[ {X}_{s} ]}_{jk} ≧ 0 , {[ {X}_{n} ]}_{kl} ≧ 0 , ∀ i , j , k , l \qquad ( 6 )$$

In Equation 6, β may be a constant and Φ_{d}(A_{S},X_{S},Xₙ) may be defined as follows:

$${Φ}_{d} ( {A}_{s} , {X}_{s} , {X}_{n} ) = {\sum }_{i} {\sum }_{j} {[ {A}_{s} {X}_{s} ]}_{ij} \cdot {[ {A}_{n} {X}_{n} ]}_{ij} \qquad ( 7 )$$

As seen in Equation 7, if the target sound A_{S}X_{S} and interference sound AₙXₙ meet having orthogonal disjointness to each other, the Φ_{-d}(A_{S},X_{S},Xₙ) value becomes zero, and otherwise, the Φ_{d}(Aₛ,Xₛ,Xₙ) value becomes a positive value. For example, if target sound is “1” and interference sound is “0” when represented on a sound spectrogram, it may be considered that they meet having orthogonal disjointedness to each other. That is, orthogonal disjointedness means that target sound and interference sound do not share any common component on a sound spectrogram.

In order to obtain A_{S},X_{S} and Xₙ to minimize the error function defined in Equation 7 after defining such orthogonal disjointedness, Equation 8 may be defined as follows and Equation 4 is applied to Equation 8, so that Equation 9 can be obtained.

$$\begin{matrix}〈 {\hat{A}}_{s} , {\hat{X}}_{s} , {\hat{X}}_{n} 〉 = {arg min}_{{A}_{s} , {X}_{s} , {X}_{n}} {J}_{disjoint} & ( 8 ) \\ {\hat{A}}_{s} : {[ {A}_{s} ]}_{lk} - {[ {A}_{s} ]}_{lk} \cdot \frac{{[ \begin{matrix}{[ ( Y - {A}_{n} {X}_{n} ) {X}_{s}^{T} ]}_{lk} - \\ β {\sum }_{i} {\sum }_{j} {[ {A}_{n} {X}_{n} ]}_{ij} \cdot {{δ}_{il} [ {X}_{s} ]}_{kj}\end{matrix} ]}_{ε}}{{[ {A}_{s} {X}_{s} {X}_{s}^{T} ]}_{lk} + μ} \\ {\hat{X}}_{n} : {[ {X}_{n} ]}_{lk} - {[ {X}_{n} ]}_{lk} \cdot \frac{{[ \begin{matrix}{[ {A}_{n}^{T} ( Y - {A}_{s} {X}_{s} ) ]}_{lk} - \\ β {\sum }_{i} {\sum }_{j} {[ {A}_{s} {X}_{s} ]}_{ij} \cdot {{δ}_{jk} [ {A}_{n} ]}_{il}\end{matrix} ]}_{ε}}{{[ {A}_{n}^{T} {A}_{n} {X}_{n} ]}_{lk} + μ} \\ {\hat{X}}_{s} : {[ {X}_{s} ]}_{lk} - {[ {X}_{s} ]}_{lk} \cdot \frac{{[ \begin{matrix}{[ {A}_{s}^{T} ( Y - {A}_{n} {X}_{n} ) ]}_{lk} - \\ β {\sum }_{i} {\sum }_{j} {[ {A}_{n} {X}_{n} ]}_{ij} \cdot {{δ}_{jk} [ {A}_{s} ]}_{il}\end{matrix} ]}_{ε}}{{[ {A}_{s}^{T} {A}_{s} {X}_{s} ]}_{lk} + μ} \\ {where [ x ]}_{ε} = max \{ x , ε \} & ( 9 )\end{matrix}$$

In Equation 9, ε, μ, etc. may be constants and may be defined as very small positive numbers.

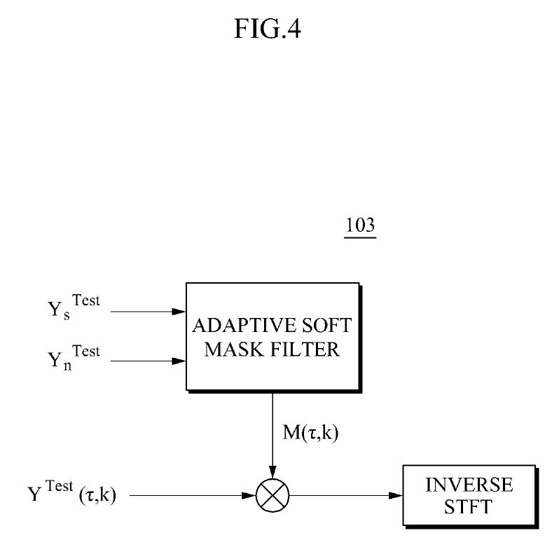

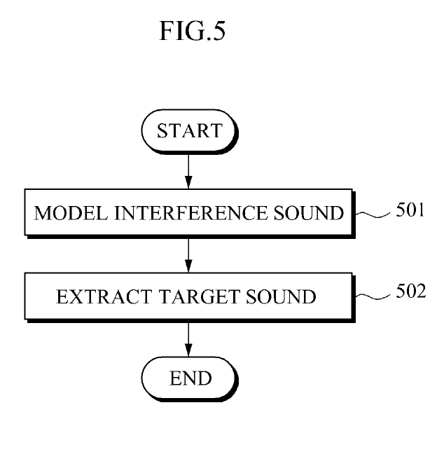

Next, a method of extracting target sound from mixed source sound is described in detail with reference to FIG. 4. This method may be an example of applying an adaptive soft masking filter.

In FIG. 4, the filter may be given as M(τ, k), wherein τ represents a time-frame axis and k may represent a frequency axis. M(τ, k) may be expressed by Equation 10.

$$M ( τ , k ) = \frac{1}{1 + exp ( - γ ( k ) \cdot ( {SNR}_{TF} ( τ , k ) - β ( τ ) ) )} \\ {SNR}_{TF} ( τ , k ) = \frac{\vert {Y}_{Tgi}^{Test} ( τ , k ) \vert}{\vert {Y}_{Intf}^{Test} ( τ , k ) \vert + ɛ} \\ β ( τ ) = {λ}_{1} + {λ}_{2} ( \frac{{\sum }_{∀ k} \vert {Y}_{lntf}^{Test} ( τ , k ) \vert}{\begin{matrix}{\sum }_{∀ k} \vert {Y}_{Tgt}^{Test} ( τ , k ) \vert + \\ {\sum }_{∀ k} \vert {Y}_{Intf} ( τ , k ) \vert\end{matrix}} ) β ( τ ) ∈ [ {λ}_{1} , {λ}_{2} ] \\ γ ( k ) = ( \frac{{σ}_{2}}{{k}^{m}} ) where m = \frac{log ( {σ}_{2} / {σ}_{1} )}{log ( NFFT / 2 )} γ ( k ) ∈ [ {σ}_{1} , {σ}_{2} ] . \qquad ( 10 )$$

As seen in Equation 10, M(τ, k) may reflect SNR_{TF}(τ, k) in an exponential decay relationship and SNR_{TF}(τ, k) may be decided as a ratio of target sound to interference sound. That is, at a certain coordinate location (τ, k), the M(τ, k) value increases when target sound is more predominant than interference sound and the M(τ, k) value decreases when interference sound is more predominant than target sound.

Accordingly, it is possible to extract only target sound by applying the filter to eliminate or reduce interference sound from mixed source sound, as seen in Equation 11.

O(τ,k)=M(τ,k)·Y^{Test}(τ,k) (11)

FIG. 5 is a flowchart illustrating a target sound extracting method according to an example embodiment. Referring to FIG. 5, the target sound extracting method may include operation 501 of modeling interference sound and operation 502 of extracting target sound.

Operation 501 of modeling interference sound may be performed in a manner for the modeling unit 101 (see FIG. 1) to apply NMF to training noise and thus extract a basis matrix for the training noise.

Operation 502 of analyzing and extracting target sound may be performed in a manner for the analysis unit 102 (see FIG. 1) to apply semi-blind NMF to mixed source sound and for the filter unit 103 (see FIG. 1) to filter the resultant mixed source sound using an adaptive filter. For example, the analysis unit 102 may separate mixed source sound into target sound and interference sound using Equations 6 through 9 and filter the mixed source sound using Equations 10 and 11.

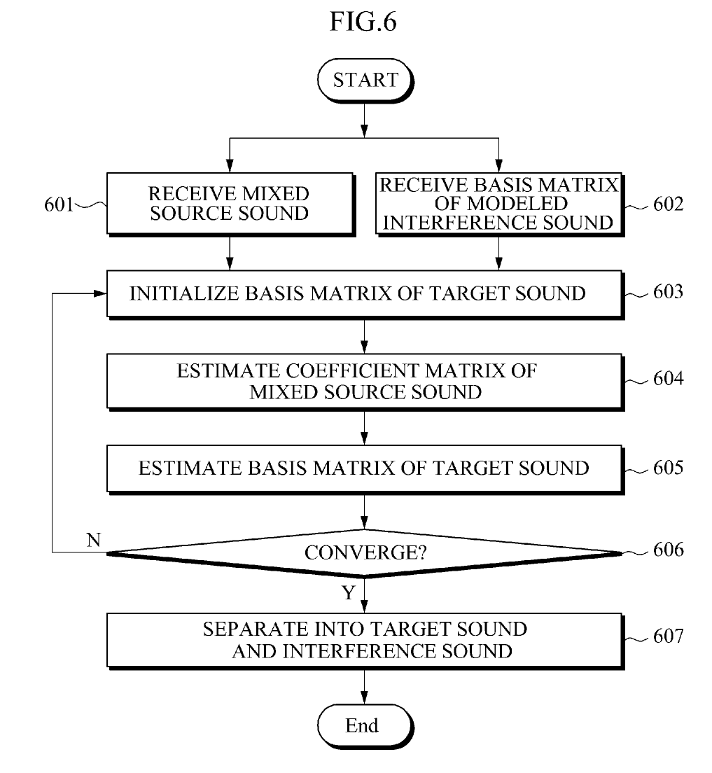

The semi-blind NMF is further described with reference to FIG. 6, below.

Referring to FIG. 6, the analysis unit 102 receives mixed source sound and a basis matrix of modeled interference sound (in operations 601 and 602). The basis matrix of the modeled interference sound may be a basis matrix of training noise extracted by applying NMF to the training noise.

Successively, the basis matrix of the target sound may be initialized to an arbitrary value (in operation 603).

Then, a coefficient matrix of the mixed source sound may be estimated (in operation 604). A least square technique may be used to estimate the coefficient matrix of the mixed source sound.

Then, the estimated coefficient matrix of the mixed source sound may be fixed, and the basis matrix of the target sound initialized to the arbitrary value is estimated (in operation 605). A least square technique may be used to estimate the coefficient matrix of the mixed source sound.

Next, it may determined whether the estimated values converge within an error tolerance limit using a given error criterion (in operation 606). The error criterion may be Equations 1 or 6 described above.

If the estimated values converge within the error tolerance limit, the mixed source sound may be separated into target sound and interference sound, and otherwise, the process is repeated.

As describe above, according to the above example embodiments, since interference sound to have to be eliminated is modeled and then eliminated or reduced, it is possible to separate mixed source sound into target sound and interference sound with high accuracy.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A target sound extracting apparatus, comprising:
a modeling unit configured to extract a basis matrix of training noise; and
a sound analysis unit configured to separate received mixed source sound into target sound and interference sound using the basis matrix of the training noise.

2. The target sound extracting apparatus of claim 1, wherein the interference sound is modeled as the basis matrix of the training noise.

3. The target sound extracting apparatus of claim 1, wherein the modeling unit is further configured to:
transform the training noise to training noise in a time-frequency domain; and
apply non-negative matrix factorization (NMF) to the transformed training noise.

4. The target sound extracting apparatus of claim 1, wherein the sound analysis unit is further configured to apply negative matrix factorization (NMF) to the mixed source sound under a presumption that the basis matrix of the training noise is the same as a basis matrix of the interference sound.

5. The target sound extracting apparatus of claim 4, wherein the sound analysis unit is further configured to:
initialize a basis matrix of the target sound to an arbitrary value;
estimate a coefficient matrix of the mixed source sound; and
estimate the basis matrix of the target sound using the coefficient matrix of the mixed source sound.

6. The target sound extracting apparatus of claim 1, wherein the sound analysis unit is further configured to separate the mixed source sound into target sound and interference sound that do not share any common components on a sound spectrogram.

7. The target sound extracting apparatus of claim 1, further comprising a filter unit configured to:
eliminate the interference sound from the mixed source sound; and
apply an adaptive filter configured to reinforce the target sound and weaken the interference sound of the mixed source sound.

8. A target sound extracting method, comprising:
extracting a basis matrix of training noise; and
separating received mixed source sound into target sound and interference sound using the basis matrix of the training noise.

9. The target sound extracting method of claim 8, wherein the interference sound is modeled as the basis matrix of the training noise.

10. The target sound extracting method of claim 8, wherein the extracting of the basis matrix of the training noise comprises:
transforming the training noise to training noise in a time-frequency domain; and
applying non-negative matrix factorization (NMF) to the transformed training noise.

11. The target sound extracting method of claim 8, wherein the separating of the received mixed source sound into the target sound and the interference sound comprises applying negative matrix factorization (NMF) to the mixed source sound under a presumption that the basis matrix of the training noise is the same as a basis matrix of the interference sound.

12. The target sound extracting method of claim 11, wherein the separating of the received mixed source sound into the target sound and the interference sound comprises:
initializing a basis matrix of the target sound to an arbitrary value;
estimating a coefficient matrix of the mixed source sound; and
estimating the basis matrix of the target sound using the coefficient matrix of the mixed source sound.

13. The target sound extracting method of claim 8, wherein the separating of the received mixed source sound into the target sound and the interference sound comprises is separating the mixed source sound into target sound and interference sound that do not share any common components on a sound spectrogram.

14. The target sound extracting method of claim 8, further comprising eliminating the interference sound from the mixed source sound, the eliminating of the interference sound comprising applying an adaptive filter for reinforcing the target sound and weakening the interference sound of the mixed source sound.
